(19) United States
(12) Patent Application Publication
(10) Pub. No.: US 2013/0271765 A1
(43) Pub. Date: Oct. 17, 2013

(54) LASER EMISSION DEVICE AND METHOD FOR THE SPECTROSCOPIC ANALYSIS OF A SAMPLE

(71) Applicants: Vincent Couderc, Verneuil-sur-Vienne (FR); Philippe Leproux, Saint-Pardoux (FR); Guillaume Huss, Limoges (FR); Annalisa De Angelis, Tivoli (FR)

(72) Inventors: Vincent Couderc, Verneuil-sur-Vienne (FR); Philippe Leproux, Saint-Pardoux (FR); Guillaume Huss, Limoges (FR); Annalisa De Angelis, Tivoli (FR)

(73) Assignee: CENTRE NATIONAL DE LA RECHERCHE SCIENTIFIQUE-CNRS, Paris (FR)

(21) Appl. No.: 13/880,305

(22) PCT Filed: Oct. 18, 2011
(86) PCT No.: PCT/EP2011/068200

§ 371 Date: Jul. 2, 2013

(30) Foreign Application Priority Data
Oct. 18, 2010 (FR) 1058472

(51) Int. Cl. G01J 3/10; G02F 1/35; G02F 1/365

(52) U.S. Cl. CPC G01J 3/10; G02F 1/365; G02F 1/3532
USPC 356/402; 359/327

(57) ABSTRACT

According to one aspect, the invention relates to a laser emission device for the spectroscopic analysis of a sample, comprising: a primary laser source (401) emitting a pump beam (I₅) and an excitation beam (I₂), said two beams being pulsed and having a nanosecond or subnanosecond pulse time; a non-linear optical fibre (406) into which the excitation beam is injected in order to form a probe beam (I₄) having a wide spectral band; a device (405) for controlling the time profile of either the pump beam or the excitation beam, allowing compensation of the time spreading of the probe beam generated by the non-linear optical fibre, in order to obtain pump and probe beams having similar pulse times; and means (409) for spatially overlaying of the pump and probe beams for the spectroscopic analysis of the sample.

### TECHNICAL FIELD OF THE INVENTION

The present invention relates to a laser emission device and method for the spectroscopic analysis of a sample, notably in nonlinear imaging applications.

### PRIOR ART

All chemical bonds have their own vibrational frequencies. The methods which aim to use light/matter interaction to obtain information on these molecular vibrations are called vibrational optical techniques. The most well known amongst these techniques is infrared (IR) spectroscopy which observes the specific absorption lines of the chemical bonds present in a sample. Discovered in 1928, Raman scattering (named after the physicist Chandrasekhara Venkata Raman who discovered the effect) makes it possible to use visible light to have access to the vibrational spectrum of molecules interacting with a light beam. In a Raman scattering process, a pump wave of angular frequency ω_{P}, incident on a molecule, is inelastically scattered in a so-called Stokes wave of angular frequency ω_{S} (FIG. 1A) and a so-called anti-Stokes wave of angular frequency ω_{AS} (FIG. 1B). The difference in frequency between the generated waves and the pump wave is a function of the molecular Raman transition (of angular frequency Ω_{R}) such that ω_{P}−ω_{S}=ω_{AS}−ω_{P}=Ω_{R}. From a photonic point of view of the process, the Stokes and anti-Stokes waves correspond to an absorption from the fundamental vibrational level and an excited vibrational level, respectively. In dense media at thermodynamic equilibrium, the process generating the anti-Stokes wave, from the excited vibrational level (B), is much less likely to occur than the process creating the Stokes wave, which is the only wave observed in practice in spontaneous Raman spectroscopy. A close study of the spectral distribution of the Stokes waves provides information about the density of the chemical bonds present in the sample. This spontaneous process of inelastic scattering is very ineffective compared to fluorescence (Raman cross sections are of the order of 10⁻³⁰ cm²/molecule, to be compared to the 1 photon absorption cross section from a fluorophore, which can be up to 10⁻¹⁶ cm²/molecule).

The stimulated Raman spectroscopy CARS (Coherent Anti-Stokes Raman Scattering) is a four-wave mixing process for targeting the vibrational bonds present in a sample. This process is described, for example, in R. W. Boyd, Nonlinear Optics (Academic Press, Boston, 1992). Two laser pulses are sent of angular frequencies ωₚ and ωₛ (or frequencies νₚ and νₛ), the difference in angular frequencies of which is made equal to the angular frequency Ω of the vibrational level to be addressed. In this resonance configuration ωₚ−ωₛ=Ω, the vibrational level of angular frequency Ω is populated by stimulated transitions and will be able to scatter inelastically the beam of angular frequency ωₚ in a beam of angular frequency ωₐₛ=2 ωₚ−ωₛ (FIG. 2A). The presence of this new radiation ωₐₛ is the signature of the presence of the bond vibrating with the angular frequency Ω in the sample. A first implementation of CARS consists of sending onto the sample two spectrally narrow picosecond pulses the difference in angular frequency of which will only address a specific vibrational bond. For an optimal identification, all of the vibrational bonds present in the sample are sought. For this, the so-called “Multiplex CARS” mode is used (see for example M. Muller and J. Schins, “Imaging the thermodynamic state of lipidic membranes with multiplex CARS spectroscopy”, Physical Chemistry B 106, 3715-3723 (2002)) where a spectrally narrow pulse ωₚ and a spectrally broad pulse ωₛ are sent onto the sample (FIG. 2B). All of the vibrational levels Ωᵢ present in the sample can thus be addressed, and a spectrum of the generated signal Wₐₛ can be obtained, thus presenting microspectroscopy applications.

A device for the implementation of CARS microspectroscopy is described for example in H. Kano et al. (“Vibrationally resonant imaging of a single living cell by supercontinuum-based multiplex coherent anti-Stokes Raman scattering microspectroscopy”, Optics Express Vol. 13, No. 4, 1322 (2005)). In the device described, the spectrally broad pulse is obtained by generating a so-called “supercontinuum” (SC) source by means of a photonic crystal fiber or PCF into which a femtosecond pulse is injected, here a 100 femtosecond pulse emitted by a Ti:Sapphire laser oscillator. A similar device is described in the American U.S. Pat. No. 7,092,086. In these examples, however, the use of a femtosecond pump beam limits the spectral resolution in the analysis of the CARS emission.

Another device for the implementation of CARS microspectroscopy is described in M. Okuno et al. (“Ultrabroadband (>2000 cm⁻¹) multiplex coherent anti-Stokes Raman Scattering spectroscopy using a subnanosecond supercontinuum light source”, Optics Letters, Vol. 32, No. 20 (2007)). A diagram of the device described in this article is shown in FIG. 3. Wave 1, emitted by a 1.064 μm Q-switched microlaser 10, is sent through a nonlinear doubling crystal 11 to form a wave 2 at 532 nm, second harmonic of the incident wave 1. Wave 2 is divided into two beams by means of a beam splitter 12. About 10% of the energy is used to form the pump beam 3 in the CARS process, and 90% is injected into a photonic crystal fiber 13 to generate the supercontinuum which will form the Stokes beam 4 in the CARS process. The two beams are focused onto the sample 14 by means of one and the same lens 15. A delay line 23 along the optical path of the pump beam 3 allows the focusing of the pump and Stokes beams to be synchronized inside the sample. A diaphragm 16 is inserted to block the pump and Stokes beams downstream from the sample, and to suppress the fluorescence emission coming from the sample. A combination of wavelength rejection and band-pass filters (17 and 18, respectively) downstream from the sample, is used to reject the pump and Stokes beams. The emitted CARS beam (reference 5) is collimated by means of a lens 19 and focused (lens 20) onto the input slit of a spectrograph 21, then detected by means of a matrix detector 22, for example a CCD camera. As opposed to the so-called picosecond or femtosecond pulsed laser sources, the pulsed laser duration of the so-called nanosecond or subnanosecond laser sources is typically comprised between a few fractions of a nanosecond (a few hundreds of picoseconds) and a few tens of nanoseconds. In this device, the use of a 1.064 μm Q-switched microlaser emitting nanosecond pulses has many advantages.

Microlasers are indeed low-cost sources with repetition rates from a few Hz to more than 100 kHz, and peak powers above 20 kW. As previously explained, these pulses serve as a pump beam for CARS microspectroscopy, and are injected into a photonic crystal fiber to generate the supercontinuum. Very good resolution (of the order of 3 cm⁻¹) is obtained due to the use of these subnanosecond sources.

However, the applicant has shown in a device such as described in FIG. 3, a nonlinear time broadening of the supercontinuum pulse generated in the photonic crystal fiber, limiting the interaction efficiency between the pump and the probe in the CARS mechanism.

One object of the invention is to provide a laser emission device suitable for the spectroscopic analysis of a sample, making it possible, notably, to overcome the limitations of the prior art.

### SUMMARY OF THE INVENTION

According to a first aspect, the invention relates to a laser emission device for the spectroscopic analysis of a sample, which comprises:
a primary laser emission source of a pump beam and of an excitation beam, the two beams being pulsed, with nanosecond or subnanosecond pulse duration;
a nonlinear optical fiber into which said excitation beam is injected to form a probe beam with a broad spectral band;
a control device for the time profile of one of said pump or excitation beams, making it possible to compensate the nonlinear time broadening of the probe beam generated by the nonlinear optical fiber in order to obtain pump and probe beams with time envelopes having substantially equal durations;
means of spatial overlapping of said pump and probe beams in view of the spectroscopic analysis of the sample.

Advantageously, the primary laser source comprises a nanosecond or subnanosecond laser emission source and a device for splitting the emitted wave into two beams of controlled powers, to form said pump beam and said excitation beam. For example, the primary source is a microlaser; for example, the microlaser emits at 1.064

According to a first variant, the control device for the time profile makes it possible to reduce the pulse duration of the excitation beam.

For example, the control device for the time profile comprises a birefringent material and a polarizer, the excitation beam being polarized at the input of the control device for the time profile, along a direction which is distinct from the birefringence axes of said birefringent material. The nonlinear rotation of the polarization due to nonlinear effects in the birefringent material associated with a given orientation of the polarizer makes it possible to cut the edges of the pulse and thus reduce the duration of the pulse. For example, the control device for the time profile comprises a birefringent fiber.

According to another example, the control device for the time profile comprises a saturable absorber material.

Alternatively, the control device for the time profile makes it possible to broaden the pulse duration of the pump beam.

According to one example, the control device for the time profile comprises a dispersive optical fiber.

Advantageously, the laser emission device further comprises an optical amplifier, upstream from said nonlinear optical fiber making it possible to regenerate the pulse to provide the spectral broadening sought in the fiber.

Advantageously, the laser emission device further comprises an optical delay line for adjusting the optical paths of the pump and probe beams, and for making possible the time overlap of the pump and probe beams inside the sample.

According to one variant, the laser emission device further comprises a nonlinear optical device for generating harmonics, into which the pump beam is injected, to generate at least a second pump beam at a different wavelength from that of the first pump beam. For example, the nonlinear optical device is a frequency-doubling device. This makes it possible, for example, to have one or two pump beams in the infrared and in the visible. Advantageously, a spectral selector may make it possible to work with one and/or the other of the two pump beams.

According to a second aspect, the invention relates to a system for the spectroscopic analysis of a sample, which comprises a laser emission device according to the first aspect, and a spectral and/or time analyzer of the wave resulting from the nonlinear interaction inside the sample of the pump and probe beams emitted by said laser emission device.

According to a third aspect, the invention relates to a laser emission method for the spectroscopic analysis of a sample, which comprises:
the emission of a pump beam and of an excitation beam, the two beams being pulsed, with nanosecond or subnanosecond pulse duration;
the injection of said excitation beam into a nonlinear optical fiber, to form a probe beam with a broad spectral band;
the control of the time profile of one of said pump or excitation beams, making it possible to compensate the nonlinear time broadening of the probe beam generated by the nonlinear optical fiber in order to obtain pump and probe beams with substantially equal durations for the time envelopes thereof;
the spatial overlapping of said pump and probe beams in view of the spectroscopic analysis of the sample.

According to a first variant, the control of the time profile of one of said pump or excitation beams comprises the reduction of the time width of the excitation beam.

According to a second variant, the control of the time profile of one of said pump or excitation beams comprises the broadening of the time width of the pump beam.

Advantageously, the laser emission method further comprises the amplification of the excitation beam before the injection thereof into said nonlinear fiber.

### BRIEF DESCRIPTION OF THE DRAWINGS

Other advantages and features of the invention will appear when reading the description, illustrated by the following figures:

FIGS. 1A and 1B (already described), principle of Stokes and anti-Stokes emission in a Raman scattering process;

FIGS. 2A and 2B (already described), principle of CARS scattering in two different modes;

FIG. 3, diagram of a laser emission source device according to the prior art (already described);

FIG. 4, diagram illustrating a first example of embodiment of a laser emission source according to the invention;

FIGS. 5A and 5B, example of a nonlinear fiber for the implementation of the invention, and calculated dispersion curve associated with the fiber;

FIG. 6, experimental curve representing the power density as a function of the wavelength at the output of the nonlinear fiber in an example of implementation of the device according to the invention;

FIGS. 7A to 7C, demonstrating the nonlinear time broadening in a photonic crystal fiber;

FIG. 8, example of embodiment of a control device for the time profile, for the implementation of the device according to the invention;

FIG. 9, diagram illustrating a second example of embodiment of a laser emission source according to the invention;

FIG. 10, experimental curve representing the power density as a function of the wavelength at the output of the nonlinear fiber in another example of implementation of the device according to the invention.

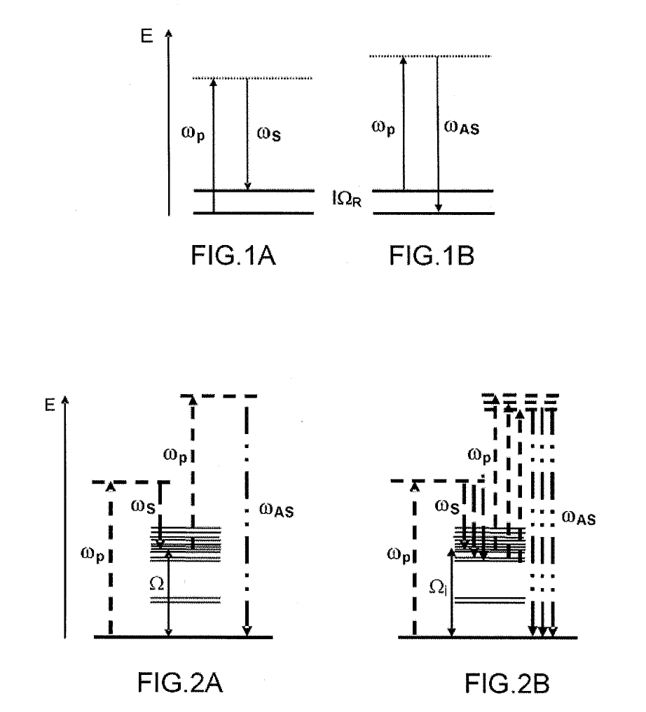

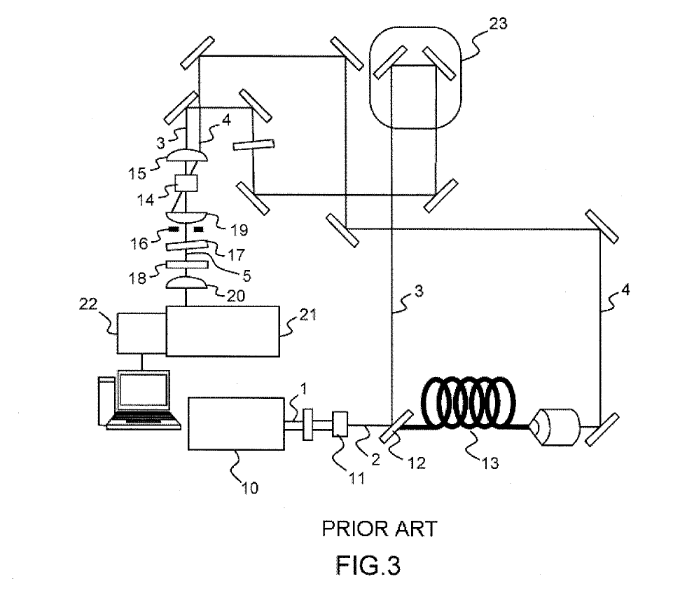

### DETAILED DESCRIPTION

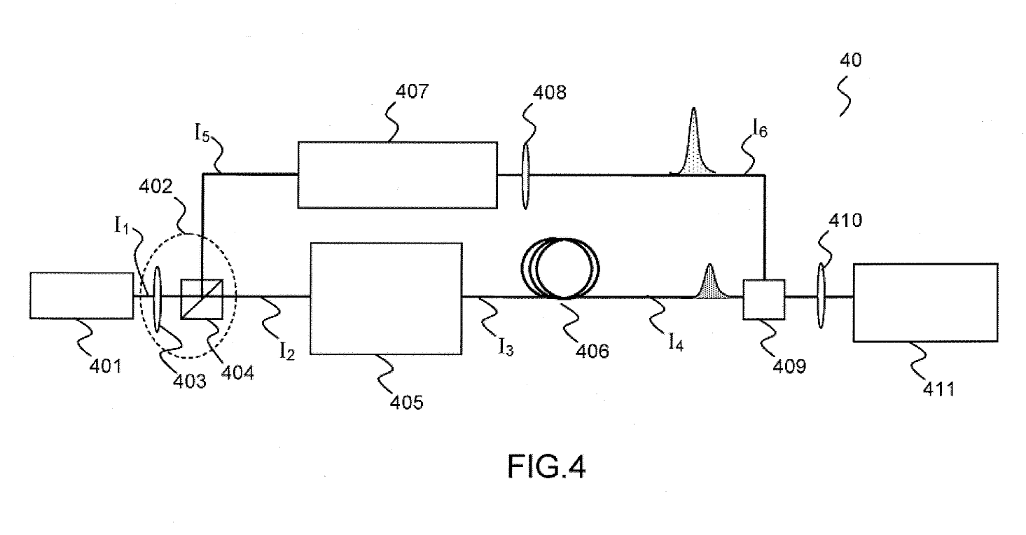

FIG. 4 illustrates an example of embodiment of a laser emission device for the spectroscopic analysis of a sample according to the invention. The device comprises a primary laser source 401 emitting nanosecond or subnanosecond pulses (I₁), typically of pulse duration comprised between 100 ps and 10 ns, for example a Q-switched laser. This is advantageously a microlaser, for example neodymium-doped, passively Q-switched by a passive and/or active saturable absorber. The wavelength is centered for example at 1.064 μm, with a narrow line width close to the Fourier limit (of the order of 800 ps). The repetition rate is for example comprised between a few Hz and 200 kHz, adjustable or not with an external Q-switching. The peak power is for example comprised between a few kW and a few tens of kW. In the example in FIG. 4, a controlled-power beam splitter 402 makes it possible to form, from the pulses I₁ emitted by the laser source 401, pulses I₂ and I₃ with energies which can be controlled. For example, the splitter 402 comprises a half-wave plate 403 and a polarizing beam splitter cube 404. The half-wave plate makes it possible to rotate the polarization of the wave emitted by the polarized (either polarized at the laser output, or by means of a polarizer) primary laser source, and thus to control the energy distribution in the two channels at the output of the polarizing beam splitter cube. The pulses I₂ and I₃ are sent to a so-called excitation channel and a so-called pump channel, respectively. The power control in each channel makes it possible for example to optimize in real time the CARS signal coming from the sample and to adjust the signal to each studied sample. In the example in FIG. 4, a half-wave plate 408 can be arranged to select the polarization of the pump beam incident on the sample. The excitation channel comprises a control device 405 for the time profile of the pulses I₂, followed by a nonlinear fiber 406 for generating a supercontinuum. The pulses I₄ and I₅, coming from the excitation and, respectively pump channels are then spatially overlapped by means of a combiner 409, for example a polarizer or a dichroic beam splitter, then sent toward a device for spectroscopic analysis 411, for example a microscope equipped with a spectroscope. The assembly of the laser emission source and of the analysis device 411 thus forms a complete system for spectroscopic analysis 40. Filters 410 can be arranged to favor a particular wavelength range making it possible to identify specific chemical compounds. An optical delay line, for example based on the principle of a Herriott cavity, can be positioned for example along the channel of the pump beam to control the time overlapping of the pump and probe beams.

The nonlinear fiber 406 enables a spectral broadening to be achieved, together with a time slicing transforming the subnanosecond signal into a series of mutually incoherent femtosecond pulses. This transformation is obtained in a nonlinear fiber provided with one or more wavelengths with zero chromatic dispersion. This spectral broadening can be simultaneously achieved in the visible and in the infrared, between for example 300 nm and 2.2 mm. A microstructured fiber can be used for this purpose, doped or not with ions such as germanium, lanthanum, phosphorus, etc. This nonlinear fiber can also consist of various bits of fibers which do not have the same features, but make it possible to minimize the group time difference between the wavelengths created by the nonlinear effect.

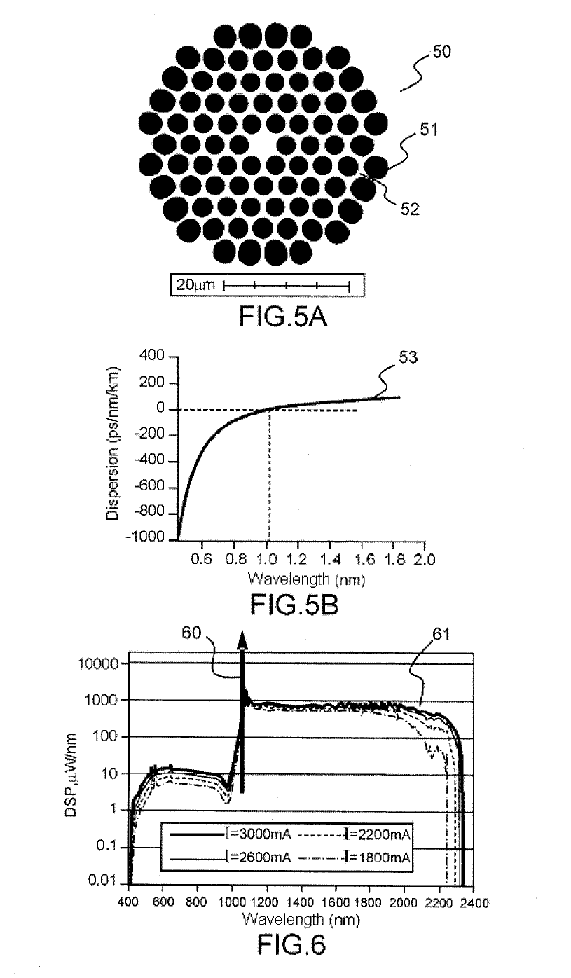

FIGS. 5A and 5B respectively illustrate an image taken with a scanning electron microscope (SEM) of an example of a nonlinear fiber suitable for the implementation of the laser emission device according to the invention, and the dispersion curve calculated for this fiber. The nonlinear fiber 50 shown in FIG. 5A is a microstructured silica fiber, i.e. having, inside a substantially cylindrical silica structure 52, substantially cylindrical air holes 51 with diameters comprised, in this example, between 2.5 and 4 μm with an average of about 3 μm.

The fabrication techniques for such a fiber are known to a person skilled in the art and described for example in the article by P. St. J. Russell, “Photonic crystal fibers,” Science 299, 358-362 (2003). The dispersion curve of the fiber is calculated by means of suitable software, for example the “COMSOL Multiphysics Simulation Software” from the company COMSOL. Starting from the geometric structures of the fiber, the dispersion given in ps/nm/km can be calculated as a function of the wavelength. It notably appears that the curve 53 obtained for the microstructured fiber shown in FIG. 5A displays zero-dispersion around 1 μm. Below the zero-dispersion, the dispersion is negative and called normal. Above, the dispersion is positive and called anomalous. The chromatic dispersion curve is used to simulate the propagation of an incident wave in the fiber taking into account all of the nonlinear effects. The software “FIBER DESK nonlinear pulse propagation”, for example, carries out such simulations (www.fiberdesk.com).

Excited at 1.064 μm, the nonlinear fiber shown in FIG. 5A makes it possible to generate a supercontinuum of which one experimental spectrum is shown in FIG. 6. The spectrum, generally indexed by reference 61, shows a dispersion of the generated wavelengths towards very long wavelengths, beyond 1.064 μm for an excitation at 1.064 μm, symbolized by the arrow 60. It is obtained with an input peak power of 10 kW making it possible to generate nonlinear effects such as: self-phase modulation, solitonic effects and parametric mixings. The choice of the microstructured fiber and of the excitation wavelength makes it possible to adjust in a known manner the supercontinuum spectrum depending upon the application sought.

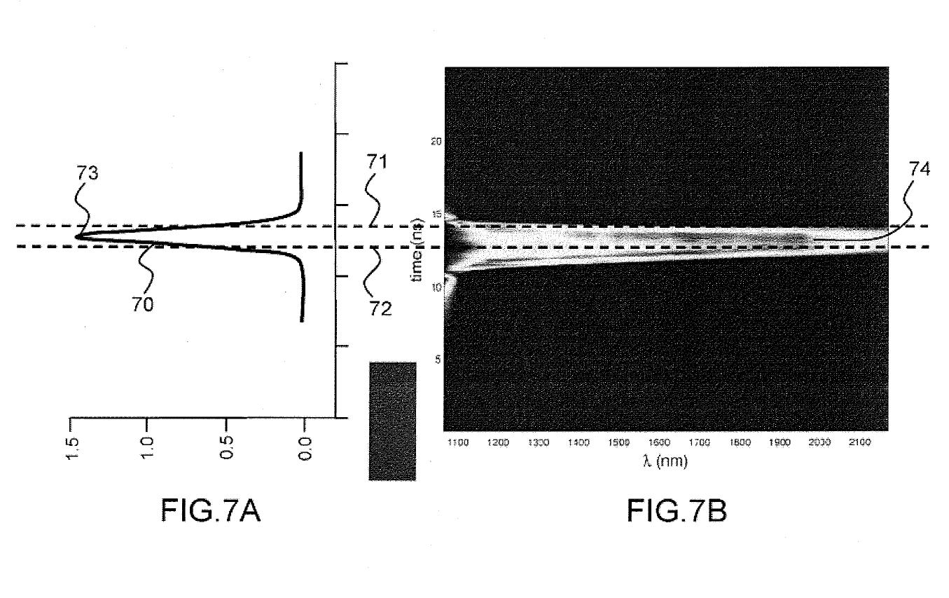

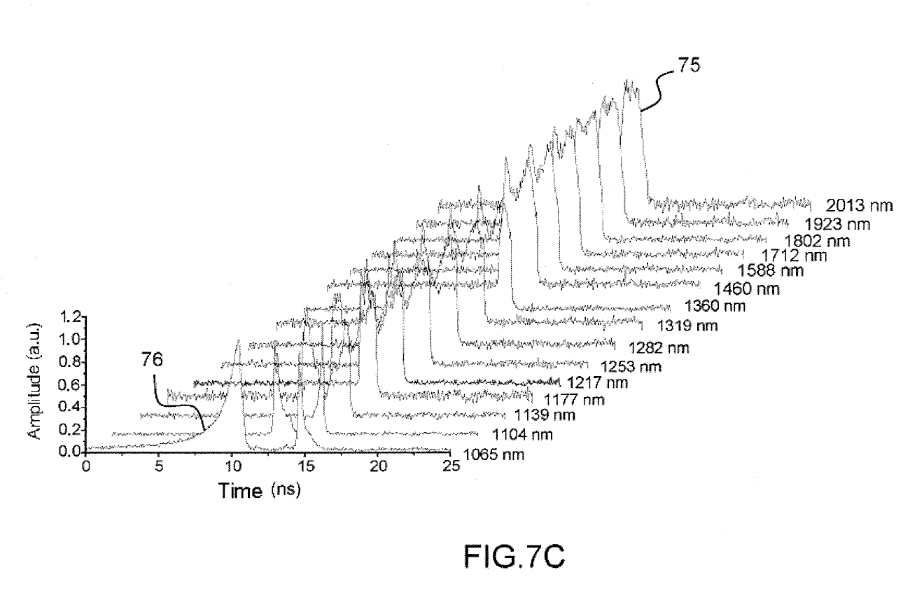

FIGS. 7A to 7C illustrate, by means of experimental curves, the time broadening generated by the nonlinear conversions, demonstrated by the applicant in the microstructured fiber (or photonic crystal fiber) shown in FIG. 5A. FIG. 7A represents the time envelope 70 of the pulse I₂ (in ns for the abscissa, and in arbitrary units for the ordinate) in one example of implementation. The envelope has a substantially Gaussian shape, the pulse duration being defined by the gap between the dotted lines 71 and 72, parallel to the ordinate axis, and which intercept the pulse envelope 70 halfway up the peak 73 thereof. FIG. 7B represents (in gray scale) the measured energy as a function of time, for each wavelength. In this figure, the darker zones correspond to the maximum energy zones. This curve demonstrates that at the base of the pulse (FIG. 7A), the power being smaller, the wavelengths generated in the supercontinuum are closer to the excitation wavelength (here, 1.064 μm). On the other hand, towards the peak of the pulse (reference 73 in FIG. 7A), the power is maximum, and the generated wavelength is more distant from the pump wavelength. An energy distribution for the different wavelengths as a function of time with a shape 74 substantially reproducing the shape of the excitation pulse can therefore be observed in FIG. 7B. FIG. 7C illustrates this phenomenon by a 3D representation showing, for different wavelengths emitted in the supercontinuum, the energy distribution as a function of time. Thus, for example, at 2013 nm (curve 75), i.e. at a wavelength distant from the excitation wavelength, the curve giving the luminous power (here, in arbitrary units) as a function of time displays a substantially similar shape to that of the excitation pulse (FIG. 7A). On the other hand, at the wavelengths close to the excitation wavelength (for example curve 76 at 1065 nm), the energy distribution occurs following two main peaks centered at times corresponding to the base of the excitation pulse. It results from this effect that it will not be possible to make coincide in time, inside the sample, the pump beam with a nanosecond pulse duration, and all of the pulses at different wavelengths of the probe beam formed by the supercontinuum. This phenomenon, demonstrated by the applicant, thus results in a nonlinear broadening of the probe beam, due to the mechanism of generating the supercontinuum in the nonlinear fiber.

An effect of the control device for the time profile of the pulse 405 (FIG. 4) is thus to reduce the pulse duration of the excitation beam in order to group together all of the pulses of different wavelengths of the supercontinuum in a time envelope substantially similar in width to that of the pump beam, the width being defined by the full-width at half maximum of the time envelope. The goal is thus to obtain a multi-wavelength pulse I₄, all of the components of which could be overlapped in time with the monochromatic source pulse.

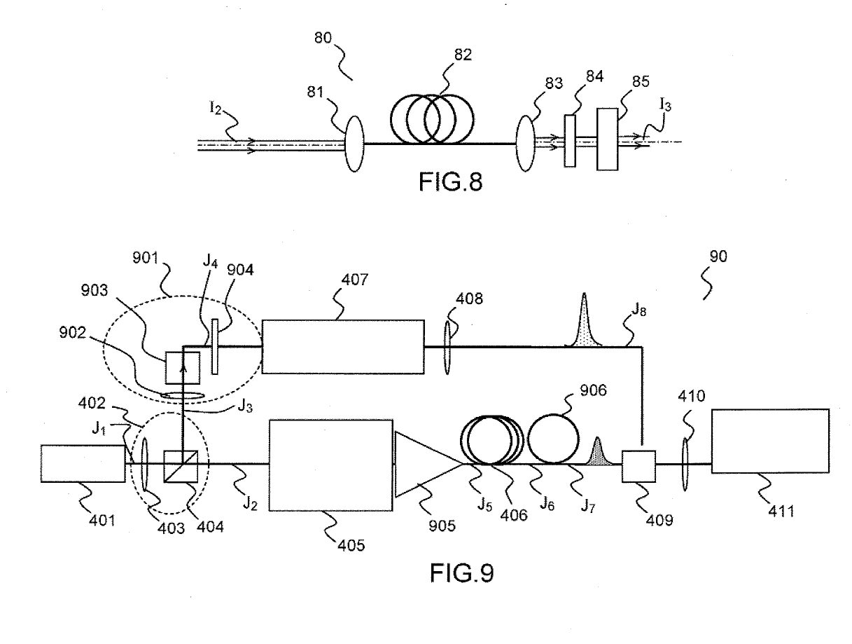

FIG. 8 shows an example of embodiment for a device 80 for reducing the pulse duration. Generally, this device comprises a birefringent material, a fiber or a piece of glass for example, and a fiber or non-fiber polarizer. In the example shown in FIG. 8, the device 80 mainly comprises a birefringent optical fiber 82 with two birefringence axes, and a polarizer 85 positioned at the fiber output. A lens 81 makes it possible to inject the incident laser beam I₂ (polarized) into the optical fiber 82, and a collimation lens 83 is used at the output of the fiber 82 to form a weakly divergent beam at the input of the polarizer 85. The laser beam I₂ undergoes effects of optical nonlinearity due to the intensity of the beam and to the birefringence of the fiber. These effects are for example self-phase modulation effects due to the Kerr effect. In particular, the Kerr effect leads to a nonlinear rotation of the polarization of the incident beam when the polarization direction at the fiber input is not collinear with the birefringence axes. Thus, when the polarizer 85 is arranged with respect to the fiber 82 so as to select an output signal, if necessary by means of a half-wave plate 84 and a polarizer 85, only the power having predominantly experienced the Kerr effect will be sampled. From this results the possibility of selecting, as a function of the orientation of the polarizer 85 and of the half-wave plate 84 when such a plate is provided, an output pulse of duration I₃ more or less long; comprised between the input pulse duration I₂ and a pulse duration reduced by a given factor, typically a maximum factor of 16. The adjustment of the output pulse duration is carried out by way of the orientation of the birefringence axes of the fiber with respect to the polarization axis of the incident beam. A half-wave plate (not shown in FIG. 8) can then be inserted upstream from the fiber to set this orientation of the polarization direction of the incident beam with the birefringence axes. The incident laser beam I₂ is generally polarized at the output of the separator 402.

If this is not the case, it is possible to provide a polarizer (not shown in FIG. 8) upstream from the fiber. With a device such as that shown in FIG. 8, it is therefore possible to adjust the pulse duration before sending the pulse into the nonlinear fiber (406, FIG. 4) to generate the supercontinuum. The birefringent fiber is for example a Corning HI 980 or Corning HI1060 fiber.

Other devices for reducing the pulse duration can be considered. It is for example possible to use saturable absorber materials, having the property of absorbing less at strong luminous intensities. An incident laser pulse which crosses such a material will then see an absorption at the base of the pulse, while the pulse peak will be transmitted, leading to a decrease in the pulse duration.

In the two examples of device mentioned below, the reduction of the time width of the pulse is accompanied by a decrease in the pulse energy. It is possible to provide an optical amplifier downstream from the control device for the time profile of the pulse (405, FIG. 4), as described hereafter.

Alternatively, it is also possible to provide a control device for the time profile of the pulse in order to broaden the duration of the pump beam so that, once again, the time envelopes of the probe and pump beams have comparable widths. Such a device can for example consist of a fiber with strong controlled dispersion (example: Maury, J; Auguste, J L; Février, S; Blondy, J M; Dussardier, B; Monnom, G; “Conception and characterization of a dual-concentric-core erbium-doped dispersion-compensating fiber”; Optics Letters, Vol. 29 Issue 7, pp. 700-702 (2004)); or of a dispersion compensation module from Teraxion (CS-TDCMX Module).

In every case, it is possible to use suitable software to calculate the expected time broadening for the nonlinear fiber, chosen to generate the supercontinuum and dimension the control device for the time profile of the pulse as a function of this broadening. In addition, the optical delay line 407 makes it possible to compensate the optical paths of the two channels so that the probe and pump beams are focused at the same time on the sample.

FIG. 9 shows a variant of the device shown in FIG. 4. Apart from the elements already described in relation to FIG. 4, the device such as described in FIG. 9 comprises, along the excitation channel, an optical amplifier 905 notably making it possible, as previously mentioned, to regenerate the signal following the passage through the device for reducing the pulse 405. The optical amplifier can be a bulk amplifier or a fiber amplifier. It is dimensioned so as to be able to amplify sufficiently the input signal which will lead to spectral broadenings in the nonlinear fiber 406. This amplifier has advantageously a pump diode the power of which can be modified. Minimization of the stimulated Raman effect can be sought within the amplifier. Two isolators (not shown in FIG. 9) can be provided, one at the input, the other at the output, to protect it against parasitic feedback. This system of optical regeneration can be studied in order to bring about, in addition to the amplification effect, a modification of the pulse phase and of the pulse envelope to facilitate the extension of the spectrum during the nonlinear conversion step.

The device also comprises, downstream from the nonlinear fiber 406, an optical fiber 906 with determined chromatic dispersion, with a suitable length to compensate the group time difference between the spectral components of the supercontinuum which can result from a long length of the nonlinear fiber 406. The goal is to perfectly re-synchronize all of the wavelengths forming the light continuum. Thus, in this example, a pulse J₁ emitted by the primary source 401 is split into a pulse J₂ in the excitation channel, and a pulse J₃ in the pump channel, by the splitter 402. In the excitation channel, the pulse reducer 405 makes it possible to reduce the excitation pulse duration J₂ which is amplified before being sent into the nonlinear fiber 406 to form the supercontinuum J₆. The fiber 906 makes it possible to compensate the difference in wave velocities in the nonlinear fiber 406, which reconstructs the time profile of a polychromatic probe pulse J₇ which is sent to the analyzer 411.

In the pump channel, the device shown in FIG. 9 comprises, in addition to the elements already described, a system 901 for generating frequencies, for example a system for doubling frequencies produced with an LBO, KTP, PPKTP, BBO, PPLN, etc. doubling crystal 903. A half-wave plate 902 can be placed in front of the doubling crystal to control the conversion effect. It is also possible to provide, downstream from the nonlinear crystal, a spectral selector 904 to select the pump wavelength according to the applications. Thus, according to one example, the pulse J₃ sent by the pulse splitter 402 towards the pump channel can be doubled by means of the wavelength conversion device 901 to form a pulse J₄, for example at 532 nm when the primary source 401 emits at 1.06 μm. Using the spectral selector 904, it is possible to choose the wavelength of the pump beam or beams J₈ which will then be sent into the analyzer 411.

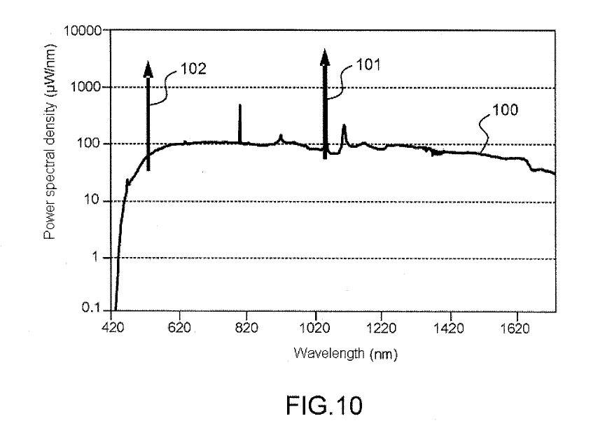

FIG. 10 thus illustrates an application according to which two pump beams at 532 nm and 1.06 μm are used (referenced 101 and, respectively, 102 in FIG. 10). In this example, the nonlinear fiber is structured to generate a supercontinuum dispersing in a broad spectrum, upstream and downstream from the excitation wavelength at 1.06 μm. The use of two pump beams in the visible and in the infrared, for example in CARS spectroscopy, may make it possible to analyze the sample in more or less depth. The pump pulse at 1.06 μm makes indeed possible a more in-depth analysis of tissues, while the pump pulse in the visible, absorbed by the sample, will make surface analysis possible. The pulse reducer in the excitation channel will make it possible to adjust the pulse durations of the probe and pump beams, and to ensure a better efficiency of the nonlinear process. The use of this double excitation at 532 nm and at 1064 nm can be accompanied by a spectral filtering of the beam J₇ to make it possible to simultaneously analyze the CARS radiations obtained by the two pump beams. This filtering will consist in sampling in the infrared, the wavelengths between 1.06 μm and 2.2 μm, and in the visible, the wavelengths between 532 nm and 700 nm. This filtering will be carried out with dielectric band-pass filters.

The applications of the laser emission device described in the present patent application are multiple and relate notably to all spectroscopy or microspectroscopy applications based on nonlinear optics mechanisms. Notably, the device according to the invention can be applied to cellular imaging with the recording of a plurality of images including spatial and time resolution, screening for chemical elements applied to hematologic diagnosis, etc.

Although described through a certain number of detailed examples of embodiments, the laser emission device and method according to the invention comprise different variants, modifications and improvements which will appear to be obvious to a person skilled in the art, it being understood that these different variants, modifications and improvements are part of the scope of the invention, as defined by the following claims.

1. A laser emission device for the spectroscopic analysis of a sample, comprising:
a primary laser emission source of a pump beam and of an excitation beam, the two beams being pulsed, with nanosecond or subnanosecond pulse duration;
a nonlinear optical fiber into which said excitation beam is injected to form a probe beam with a broad spectral band;
a control device for the time profile of one of said pump or excitation beams, making it possible to compensate the nonlinear time broadening of the probe beam generated by the nonlinear optical fiber in order to obtain pump and probe beams with time envelopes having substantially equal pulse durations;
means of spatial overlapping of said pump and probe beams in view of the spectroscopic analysis of the sample.

2. The laser emission device as claimed in claim 1, wherein the control device for the time profile makes it possible to reduce the pulse duration of the excitation beam.

3. The laser emission device as claimed in claim 2, wherein the control device for the time profile comprises a birefringent material and a polarizer, the excitation beam being polarized at the input of the control device for the time profile, along a direction which is distinct from the birefringence axes of said birefringent material.

4. The laser emission device as claimed in claim 3, wherein the control device for the time profile comprises a birefringent fiber.

5. The laser emission device as claimed in claim 2, wherein the control device for the time profile comprises a saturable absorber material.

6. The laser emission device as claimed in claim 1, wherein the control device for the time profile makes it possible to broaden the pulse duration of the pump beam.

7. The laser emission device as claimed in claim 6, wherein the control device for the time profile comprises a dispersive optical fiber.

8. The laser emission device as claimed in claim 1, wherein the primary laser source comprises a nanosecond or subnanosecond laser emission source and a device for splitting the emitted wave into two beams of controlled powers, to form said pump beam and said excitation beam.

9. The laser emission device as claimed in claim 8, wherein the primary laser source is a microlaser.

10. The laser emission device as claimed in claim 1, further comprising an optical amplifier, upstream from said nonlinear optical fiber.

11. The laser emission device as claimed in claim 1, further comprising an optical delay line for adjusting the optical paths of the pump and probe beams.

12. The laser emission device as claimed in claim 1, further comprising a nonlinear optical device for generating harmonics, into which the pump beam is injected, to generate at least a second pump beam at a different wavelength from that of the first pump beam.

13. A system for the spectroscopic analysis of a sample, comprising:
a laser emission device as claimed in claim 1;
a spectral and/or time analyzer of the wave resulting from the nonlinear interaction inside the sample of the pump and probe beams emitted by said laser emission device.

14. A laser emission method for the spectroscopic analysis of a sample, the method comprising:
emission of a pump beam and of an excitation beam, the two beams being pulsed, with nanosecond or subnanosecond pulse duration;
injection of said excitation beam into a nonlinear optical fiber, to form a probe beam with a broad spectral band;
control of the time profile of one of said pump or excitation beams, making it possible to compensate the nonlinear time broadening of the probe beam generated by the nonlinear optical fiber in order to obtain pump and probe beams with time envelopes having substantially equal durations; and
spatial overlapping of said pump and probe beams in view of the spectroscopic analysis of the sample.

15. The laser emission method as claimed in claim 14, wherein the control of the time profile of one of said pump or excitation beams comprises the reduction of the time width of the excitation beam.

16. The laser emission method as claimed in claim 14, wherein the control of the time profile of one of said pump or excitation beams comprises the broadening of the time width of the pump beam.

17. The laser emission method as claimed claim 15, further comprising the amplification of the excitation beam before the injection thereof into said nonlinear fiber.
